(19) United States
(12) Patent Application Publication
(10) Pub. No.: US 2025/0018633 A1
(43) Pub. Date: Jan. 16, 2025

(54) SCREEN WHEEL FILTER DEVICE FOR THE HIGH-PRESSURE FILTRATION OF A PLASTIC MELT

(71) Applicant: Gneuss GmbH, Bad Oeynhausen (DE)

(72) Inventors: Stephan Gneuss, Bad Oeynhausen (DE); Daniel GNEUSS, Charlotte, NC (US); Detlef GNEUSS, Carabietta (CH)

(73) Assignee: Gneuss GmbH, Bad Oeynhausen (DE)

(21) Appl. No.: 18/902,644

(22) Filed: Sep. 30, 2024

Related U.S. Application Data
(63) Continuation of application No. PCT/DE2023/100209, filed on Mar. 17, 2023.

(30) Foreign Application Priority Data
Apr. 7, 2022 (DE) 10 2022 108 498.1

(51) Int. Cl. B29C 48/691

(52) U.S. Cl. CPC B29C 48/6914

(57) ABSTRACT

A screen wheel filter device is provided for the high-pressure filtration of a plastic melt. At least one spacing element is arranged between an inlet plate and an outlet plate and a bearing ring on which a screen wheel arranged between the inlet plate and the outlet plate, is rotatably mounted. A tensioning bolt is guided through the bearing ring and via which the inlet plate together with the outlet plate, including the bearing ring inserted therebetween, is braced. The screen wheel has a plurality of screen segments which can each be positioned between the inlet channel and the outlet channel and through each of which a flow can pass. A throughflow region is formed between the opening in the inlet channel and the opening in the outlet channel facing toward the screen wheel in each case.

This nonprovisional application is a continuation of International Application No. PCT/DE2023/100209, which was filed on Mar. 17, 2023, and which claims priority to German Patent Application No. 10 2022 108 498.1, which was filed in Germany on Apr. 7, 2022, and which are both herein incorporated by reference.

### BACKGROUND OF THE INVENTION

### Field of the Invention

The invention relates to a screen wheel filter device for the high-pressure filtration of a plastic melt.

### Description of the Background Art

When filtering plastic melts, agglomerates or solid particles must be filtered out before the melt may be supplied with a nozzle to a further-processing system, such as an extrusion apparatus. To facilitate an uninterrupted production, different designs of filter devices are known, which permit the replacement of a filter screen during ongoing operation in that a new uncontaminated screen is introduced into the flow channel, and the contaminated one is removed therefrom. One particular difficulty in filtering plastic melts is that this must take place at high temperatures and at high pressures, which are already between 250 bar and 300 bar in normal applications.

A generic filter device is fundamentally described in DE 3302343 A1 and EP 0 569 866 A1, which corresponds to U.S. Pat. No. 5,362,223, and which are all herein incorporated by reference. It facilitates the filtration of plastic melts and other medium to highly viscous fluids, the delimitation from low-viscous media being determined by the design, as explained below. The screen wheel, which carries the individual screen elements, is positioned between two housing plates, which are held at a certain distance from each other so that, on the one hand, the screen wheel is still rotatable and, on the other hand, the gap between the sealing surfaces of the screen wheel and the adjacent sealing surfaces of the housing plates is so narrow compared to the viscosity of the filtered medium that no leakage flows occur which form in the gap open to the outer sides. In short, no hermetic seal in the direction of the outside is achieved in a generic screen wheel filter device, but instead the gap width is kept so small that the medium is unable to flow to the outside along the outwardly open gap between the screen wheel and the housing, due to its viscosity. However, aqueous media of low viscosity would flow out at the edge and may therefore not be processed, due to the open design of the screen wheel filter device.

DE 3341508 A1, which corresponds to U.S. Pat. No. 4,619,600, which is incorporated herein by reference, shows a further generic filter device, in which a drive device is also disclosed. The latter is made up of a drive element in the form of a hydraulic cylinder, which is fastened on a side edge of the housing, a transmission lever, as well as a free-wheel unit made up of a pinion, which engages with an outer toothing of the screen wheel, and a free-wheel, which permits a return movement of the transmission lever without moving the screen disk.

DE 3522050 A1 shows a screen wheel filter device, including drive via a pawl toothing formed over an outer circumference of the screen wheel and including a feed tappet, which engages with the toothing to gradually move the screen wheel.

A screen wheel filter device is described in DE 299 08 735 U1, which includes a backflushing apparatus. An apparatus for increasing pressure in the backflushing line is provided for backflushing. An operation of the filter device at high pressures and measures for containing leakage flows are not disclosed.

DE 39 02 061 A1, which corresponds to U.S. Pat. No. 5,090,887, which is incorporated herein by reference, also describes a screen wheel filter device, which includes a backflushing apparatus, which is not particularly suitable for high-pressure applications.

The screen wheel filter device illustrated in WO 2014/184 220 A1, which is incorporated herein by reference, is aimed at minimizing pressure fluctuations, but is also not explicitly provided and suitable for high-pressure applications.

The special advantages of a generic filter device are that a multiplicity of individual screens may be placed on the screen wheel, through which a flow may successively pass, and which are easily accessible or may be replaced for cleaning purposes in a position on the housing facing away from the flow channel. The construction of the filter device is also simple and cost-effective, due to the layered construction.

However, the main difficulty lies in the sealing between the outer housing plates and the screen wheel enclosed therebetween. The housing parts must be braced against each other, including the screen wheel, in such a way that the flow pressure does not effectuate too great a widening of the housing, and no corresponding leakage points may form thereby, through which too much fluid emerges at the side edges of the housing. At the same time, a mobility of the screen wheel must nevertheless be continuously given, the latter no longer being able to rotate if it is clamped too tightly. A certain minimum gap width between the end-face sealing surfaces on the screen wheel and the opposite contact surfaces on the housing-side inlet and outlet plates must thus be given in all operating states. The necessary gap width depends on the fluid to be processed in each case and its viscosity, on the processing temperature, and on the flow pressure in the region of the screen segment. While the tightness against leakage flows in the direction of the edge is a fundamental objective, a sufficient gap width is nevertheless also always necessary, so that a very slight emergence of the fluid past the sealing strips remains possible, and a kind of lubricating film forms on both end faces of the screen wheel by the fluid itself.

A corresponding adaptation of the height of the screen wheel and the height of the spacer elements, which are also positioned between the inlet and outlet plates and enclose the screen wheel, make it possible to adjust the gap width specific for the intended processing process, which, however, is in the range of just a few micrometers, so that it is very difficult to manufacture the spacer elements and the associated screen wheel, which together form the so-called inner pairing inserted between the inlet and outlet plates. It has been shown in practice that, even if the gap widths are meticulously calculated and produced, problems regarding the mobility of the screen wheel still arise, which may be eliminated only by reducing the pretensioning, which, in turn, results in leakage problems.

In the case of modern concepts of a screen wheel filter device which are known per se, at least two screen segments in each case are simultaneously in the cross-sectional area through which the flow passes, which is referred to below as the through-flow region. The through-flow region is the surface area usable for the filtration and subject to frontal inflow. A first screen segment is usually situated such that it partially overlaps the through-flow region, so that the operating pressure builds up in the incoming screen cavity. A further screen segment is positioned completely or almost completely within the through-flow region. A part of the second screen segment or a part of the third screen segment is situated on the upper edge, viewed in the rotation direction, partially overlapping the through-flow region. The screen cavities intersected by the through-flow region, which move into or out of this region, are however completely under operating pressure, even if they have only a small overlap with the through-flow region in terms of surface area. The pressure region is therefore greater than the through-flow region, and a largely pressure-constant operation of the filter device is facilitated, since no angular position of the screen wheel exists, in which the flow path is interrupted entirely or by an essential portion.

The plastic enclosed in the screen segment blocked in such a way remains under the operating pressure of up to 500 bar. As a result, not only the region through which the flow passes directly and the adjacent surface areas of those screen segments under pressure which partially overlap the through-flow region, but also those screen cavities which have already moved out of the pressure region through which the flow is actively passing. Assuming a usual number of at least 10 screen segments, in particular 13 screen segments, on the screen wheel, the region under pressure extends in the rotation direction between a first screen segment, which has just begun to partially overlap the through-region, up to the last screen segment before entering a screen changing position. Consequently, more than half of the screen segments arranged on the screen wheel are under high internal pressure and contribute to widening the lubricating gap and cause leakage flows.

Situations are described in DE 10 2017 100 032 A1, which corresponds to US 2019/0344491, which is incorporated herein by reference, which arise in relation to the geometry of the screen gap during operation. The gap width is not a geometrically constant size during operation, since due to the internal pressure during filtration, by inserting a gap width adaptation layer between the spacer elements and one of the adjacent housing plates, a certain operating point may be set in such a way that, on the one hand, the gap is sufficiently large to be filled with the fluid used as a lubricant and to facilitate the movement of the screen wheel and, on the other hand, the gap width is limited with respect to a maximum internal pressure during operation so that no greater leakage flows occur. Uncontrolled leakage flows are to be avoided, since assemblies arranged on the outside of the filter device, such as sensors, a swiveling door at a screen changing station, or the drive for gradually rotating the screen wheel, are impaired by emerging fluid which solidifies on the outside. Such a setting of the operating point is readily possible for usual operating pressures from approximately 250 bar to a maximum of 300 bar, in particular, by inserting a gap width adaptation layer, the mobility of the screen wheel in the nearly unpressurized state should be made possible to the same extent as preventing or reducing leakage flows at the maximum operating pressure.

The difficulty of the adaptation for a certain operating state therefore does not lie in the ability to design the filter device for a high operating point which is constant within narrow limits, but rather to ensure an operation in the nearly unpressurized state as well as up to the maximum operating pressure. This is where the known concepts for the aforementioned maximum pressures of 250 bar to 300 bar reach their limits.

### SUMMARY OF THE INVENTION

It is therefore an object of the present invention to provide a high-pressure screen wheel filter device, in which the functional capability of the filter device is to be ensured in an unpressurized state as well as in another operating point, in which the fluid is pressed through the filter device at a high pressure of 500 bar or more without individually adapting the pretensioning of the housing parts prior to or during operation.

This object is achieved by a screen wheel filter device for the high-pressure filtration of a plastic melt.

The concept according to the invention provides a fundamentally unchanged design of a screen wheel filter device, in which, however, the housing tensioning bolts which carry the bearing ring, the bearing ring itself, as well as the surface area of the screen segment through which the flow passes, and the adjacent pressurized screen segments are coordinated with each other in a particular way.

On the whole, as a result of this coordination for the high-pressure filtration of at least 500 bar, the outer diameter of a screen wheel, which limits the screen cavities and forms the beginning of an outer annular sealing surface on the screen wheel, is approximately the same size as that of a screen wheel filter device according to the prior art. The housing is thus also approximately the same size.

However, while the diameter of the inner annular sealing surface according to the prior art, which limits the screen cavities, is selected to be as small as possible to enlarge the radial extension and thus the usable screening surface for the filtration, the screen segments according to the invention are displaced more to the outer edge of the screen wheel. The inner bearing ring and/or the inner sealing surface on the screen wheel protrude as large, apparently useless, surface areas. The invention thus intentionally departs from the obvious approach of enlarging the usable screen surface on the screen wheel for filtration with a given size of the housing of the filter device, or to reduce the size of the housing of the filter device with a given screen surface. The arrangement provided according to the invention of small screen segments on the outer edge of a screen wheel of large diameter is senseless and presumably economically disadvantageous at first glance.

The invention provides a particular geometric coordination of the bearing ring, the housing tensioning bolts, and the so-called active pressure surface region. The active pressure surface region encompasses all surfaces of those screen segments which are under operating internal pressure at the same time. This is a surface projected onto the inlet and outlet plates, i.e., the surface which, in connection with the operating internal pressure, applies the widening force to the housing and thus induces a spreading of the lubricating gap between the screen wheel and the adjacent surfaces of the housing.

The surface area of the active pressure surface region is generally larger than the through-flow region, since screen segments whose surface only partially overlaps the through-flow region are nevertheless completely under operating internal pressure. It is provided that: a cross-sectional area A2 of the bearing ring is at least 9 times, in particular 9 to 13 times, a cross-sectional area A1 of the central tensioning bolt; and the cross-sectional area A1 of the central tensioning bolt is 0.1 times to 0.4 times the area A3 of the active surface region.

A certain slenderness ratio of the active pressure region is preferably predefined by area A3, the middle length of the arc-shaped active pressure surface region being 1.9 times to 2.5 times the radial width. For this purpose, the length is measured on a middle semicircle which runs through the center of the screen segment. If the screen segment does not have a symmetrical contour, the surface center of gravity of the screen segment is instead selected for the semicircle. In addition to the other geometric relationships, it is thus provided that the active zone is long and narrow rather than short and wide.

In light of the high pretensioning forces and the surface pressures resulting therefrom, an example provides that the thickness of the inlet block and the outlet block are each 2.5 times to 3.5 times the thickness of the bearing ring inserted therebetween and/or the spacer elements.

The active pressure surface region should be limited to the region adjacent to the openings of the inlet and outlet channels. To prevent the screen cavities from remaining under pressure after they have moved out of the through-flow region, it is advantageous to provide at least one pressure relief bore in the housing, which opens into the path over which the screen segments pass during the rotation of the screen wheel and is fluid-conductively connected to an outside of the housing via a flow channel. The region of the pressure relief bore thus forms a pressure sink, and a tangential flow path is created, which essentially extends from the pressurized, closed screen cavity in the direction of rotation.

Those screen cavities through which flow previously passed and are still under pressure undergo an abrupt pressure relief thereby when they are moved out of the through-flow region. As a result, a widening of the housing and an enlargement of the gap between the screen wheel and the adjacent housing plates are effectuated only by the screen segments through which flow directly passes. However, no screen chambers under pressure for a longer period of time remain which contribute to the widening of the housing outside the pressure zone and in which a pressure decrease is only gradually possible, due to leakage flows.

The tangential pressure relief provided according to the invention now takes place in such a way that the top front screen segment in the rotation direction overlaps the opening of a pressure relief bore once this screen segment has completely left the pressure region and no flow connection exists anymore to the region through which the flow passes. For this purpose, it is geometrically provided that the pressure relief bore opens in the path over which the screen segments pass during the rotation of the screen wheel and is fluid-conductively connected to an outside of the housing via a flow channel. It is important that the distance between the opening of the pressure relief bore and the top front edge of the funnel opening of the inlet and outlet channels, viewed in the rotation direction, is always larger than the maximum arc length of the screen segments. This results in the fact that the screen cavity is first completely separated from the region through which the flow passes, and the screen wheel must then rotate a little farther until a flow connection between the closed screen cavity, which is still under pressure, and the pressure relief bore may set in.

Since plastic melts are compressible, the pressure relief takes place independently in that a small amount of plastic melt emerges and is removed at the pressure relief bore. The outflow of plastic melt from the screen cavity ends abruptly again with the completed pressure compensation, i.e., the screen cavity remains filled.

In that a one-time pressure relief of any contaminated screen segment is effectuated in a targeted manner according to the invention, the number of pressurized screen cavities may be limited to a maximum of three, at least two of which partially overlap the through-flow region during operation, and one is moved to the pressure relief bore.

Since it is necessary for the purpose of pressure relief to remove small amounts of the plastic fluid compressed in the screen segment, the discharge preferably takes place starting from the pressure relief bore through a pressure relief channel, which leads to the backflushing region usually present on the underside of the screen wheel filter device. Dirt particles adhering to the screen elements may be dislodged by the backflushing apparatus, for which purpose the discharge of the plastic melt, including the dirt particles, is necessary, so that the underside of the filter device must be kept free of other apparatuses, and suitable collecting devices may be provided there.

In particular, the pressure relief bore is provided on the side of the inlet plate. The backflushing channel and the pressure relief channels should end, if possible, in the same region of the filter device, namely in its lower region, since the material may then be conducted from there directly into a collecting container positioned below the filter device by the force of gravity.

It is also possible to provide at least one pressure relief bore on the side of the outlet plate, since cleaned melt is present there, and to connect the pressure relief bore directly to the unpressurized part of the backflushing channel in the housing outlet plate. As a result, the backflushing of the screen insert elements in the screen cavities, which is necessary in any case, may be at least partially effectuated with the quantity of plastic melt which was discharged via the tangential flow path for the purpose of pressure relief. An additional function may thus be executed by the intermittently emerging fluid for pressure relief purposes, and the power of the drive device of the backflushing device may be reduced, by means of which, for example, a piston is moved to carry out the backflushing. In addition, less melt must be diverted from the production flow for the backflushing.

In the case of a screen wheel filter device which is provided with a backflushing device in any case, the pressure relief according to the invention thus does not on balance induce a greater loss of the filtered medium.

A further example provides to additionally facilitate at least one radial pressure relief flow path.

In this sense, “radial” can be meant to be a flow from the position of the screen cavities on the screen wheel inwardly to the center or outwardly to the outer circumference without the flow direction having to take place strictly radially in the geometrical sense.

In particular, the bearing ring, on which the screen wheel is mounted in a sliding manner, may be used for further pressure relief. Plastic melt which flows through the screen gap widened in the neighborhood of the pressure region enter the bearing ring, which is also generally intended for the purpose of forming a friction bearing. In high-pressure mode, however, more plastic melt overflows locally into the region of the bearing ring than is needed there for lubrication. To prevent axial leakage flows from forming along the bearing ring, which emerge on the front of the housing inlet or outlet plate, at least one additional pressure relief bore is provided, which is preferably situated in an angular position next to or beneath the through-flow region, at most up to the lower low point of the bearing ring. If the screen segment through which the flow passes is situated, for example, at a 3 o'clock position, 12 o'clock representing the housing upper side and 6 o'clock the housing underside, the radial pressure relief bore is then preferably arranged at a position between 2 o'clock and 6 o'clock.

A further example provides to capture and divert the initiating leakage flows which set in from the pressure region to the outer circumference of the screen wheel. They enter the region of the outer toothing of the screen wheel, which is needed for driving. If plastic melt sticks thereto and is transported to the outside of the housing, it may solidify, which possibly results in impairment of the drive after multiple rotations of the screen wheel. To counteract this, it is provided according to the invention to introduce a further pressure relief opening into the gap between the toothing on the outer circumference of the screen wheel and the adjacent spacer element, so that any melt which may have penetrated the gap may be discharged to the outside by the force of gravity, in particular also to the lower region of the housing, from where it may flow out into a collecting container set thereunder.

It is advantageous to provide the at least one tangential pressure relief channel on the side of the inlet plate, because a free access to the screen cavity exists there, while, facing away therefrom, i.e., on the back side of the screen wheel, the opening is at least partially covered by the perforated plate inserted into the screen cavity, which supports the actual screen elements.

The cross-section in the flow direction—i.e., from the pressure relief bore to a discharge opening on the housing underside-does not decrease over the course of the flow path, but instead preferably widens. This prevents foreign bodies or plastic plugs, which have been deposited, for example, from leftover material from previous production cycles, or degraded material from being able to cause a jam in the channel, which would then hinder the pressure relief. This example with an expanding channel cross-section preferably applies to all channels for removing material from the housing to a collecting tray.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a top view of an intermediate plane of a screen wheel filter device according to the prior art;

FIG. 2 shows a top view of a screen wheel of a screen wheel filter device according to the invention.

FIG. 3 shows a perspective view of a housing of the screen wheel filter device;

FIG. 4 shows the perspective view as in FIG. 1, the inlet plate of the housing being removed;

FIG. 5 shows a perspective view of the screen wheel filter device without the screen wheel in an intermediate plane;

FIG. 6 shows a perspective view of the screen wheel filter device, including a partially cutaway and transparently illustrated inlet plate;

FIG. 7 shows a perspective view of the screen wheel filter device, including the screen wheel, in an intermediate plane;

FIG. 8 shows a perspective sectional view of the rotation axis of the screen wheel;

FIG. 9 shows an enlarged detail from FIG. 8; and

FIG. 10 shows a bracing diagram for parts of the filter device.

### DETAILED DESCRIPTION

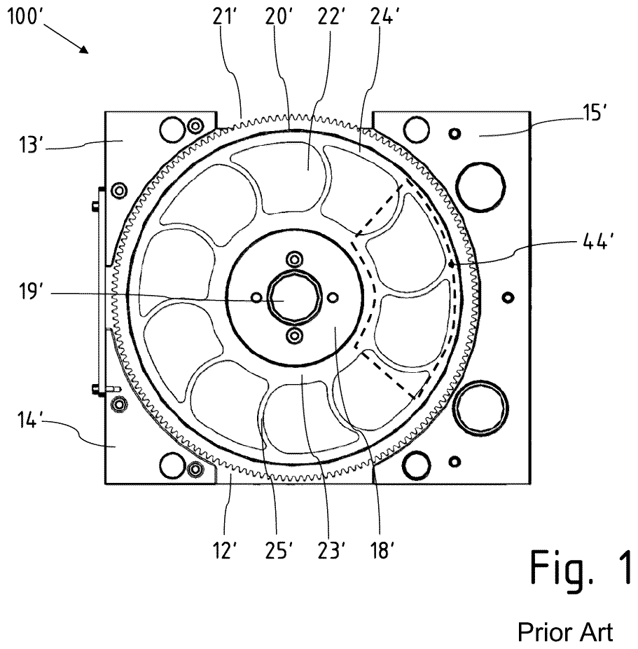

FIG. 1 is a top view of an intermediate plane of a screen wheel filter device 100′ according to the prior art. An inlet plate, via which the fluid is conducted to screen sections 21′ on a rotatable screen wheel 20′, has been removed. An outlet plate 12′ is arranged in the background, via which the fluid is conducted away from particular screen segment 21′ to the outside. Screen segments 21′ are each limited by an annular inner sealing surface 23′ and an annular outer sealing surface 24′ as well as by strips 25′, which extend between inner sealing surface 23′ and outer sealing surface 24′. The screen wheel is framed by two smaller intermediate plates 13′, 14′ on the left and a larger intermediate plate 15′ on the right. A pressurized active pressure surface region 44′, indicated by the dashed line on screen wheel 20′, is situated in the region of intermediate plate 15′. A bearing ring 18′, through which a housing tensioning bolt 19′ is guided, also belongs to the intermediate plane. Screen wheel 20′ is mounted on bearing ring 18′; a friction bearing is formed therebetween.

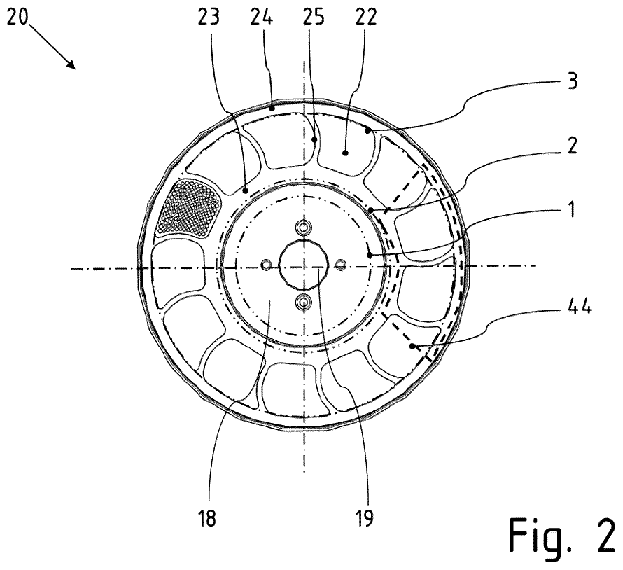

FIG. 2 shows the top view of a screen wheel 20 optimized according to the invention, including a total of 13 screen segments 21. Outer diameter 3 of outer sealing zone 24 and simultaneously of the outer edge of screen segments 21 is unchanged from screen wheel 20′ in FIG. 1.

The outer diameter of bearing ring 18 is much larger. For comparison, circumferential line 1 shows the circumference of bearing ring 18′ from FIG. 1. Inner sealing surface 23 and the inner limit lines of screen segments 21 are thus also shifted to the outside. For comparison, circumferential line 2 shows the corresponding circumference from FIG. 1.

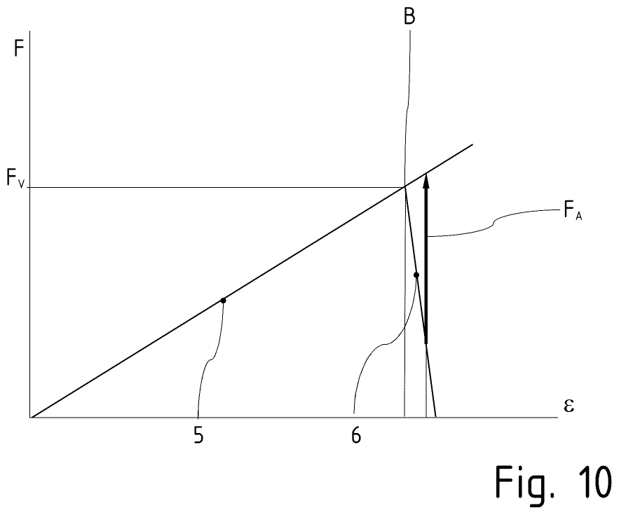

In FIG. 10, force F is plotted over expansion & in the housing tensioning bolt/bearing ring/housing plates system in the form of a bracing diagram. This is a qualitative drawing, which is not true to scale, based on which the following example of the configuration of a screen wheel filter device according to the invention is to be explained:

A surface area A3 of the active pressure surface region, which relates to three screen segments 21, is specified with A3=100 cm². The configuration for high-pressure filtration assumes a maximum operating pressure of 500 bar. With this pressure, a widening force of 500 kN arises in the active pressure surface region, corresponding to approximately 50 to, which leads to the widening of the screen gap between screen wheel 20 and inlet plate 11 or between screen wheel 20 and outlet plate 12 and to increased leakage flows resulting therefrom. The slope of line 5 in FIG. 10 corresponds to the spring constant of tensioning bolt 19, which is guided through bearing ring 18.

The package of inlet plate 11, bearing ring 18, and outlet plate 12 pretensioned by housing tensioning bolt 19 may be viewed with sufficient accuracy as a uniform flange with the cross-sectional area of bearing ring 18, since inlet plate 11 and outlet plate 12 are extremely rigid, in particular if the thickness of inlet and outlet plates 11, 12 are each set to 2.5 times to 3.5 times the height, i.e., the axial extension, of bearing ring 18.

For example, the surface area of the tensioning bolt is A1=33 cm², and the ring surface area is A2=357m². Since the cross-sectional area on bearing ring 18, i.e., after removing the central bore for the tensioning bolts, is an annular area A2 whose absolute value is approximately 10 times the cross-sectional area A1 of tensioning bolt 19, the spring constant is approximately 10 times higher; the slope of line 6 corresponds to this spring constant—quantitatively, not true to scale.

A pretensioning force Fv is applied at an operating point B, which results in a compression of the package described above. Widening force FA prevailing as a maximum during operation partially relieves the compressed package without releasing the pretensioning entirely.

The lines perpendicular to the abscissa indicate, on the one hand, the deformation with an applied pretensioning force-without a widening force as a result of the pressure flow—and, on the other hand, with the application of pressure during operation.

The pretensioning is set in such a way that the lubricating gap between inlet plate 11 and screen wheel 20 and between outlet plate 12 and screen wheel 20 are minimal, or even such that the lubricating gap is no longer present at all.

It is clear from the schematic representation in FIG. 10 that the deformation change during operation is only very slight, because the surface area relationships provided according to the invention between areas A1 and A2 are selected to be in a ratio of 1:9 to 1:13 and therefore deviate significantly. In the diagram, this results in the much higher slope of line 6 and in such a slight expansion change during operation that excessive gap widenings and stronger leakage flows resulting therefrom are avoided.

This computational configuration then results in the structural design that was explained above on the basis of the comparisons in FIGS. 1 and 2, the screen segments according to the invention being narrower compared to the prior art and shifting optically farther to the outer edge, and an apparently over-dimensioned bearing ring opposing the usual efforts to maximize screen surface areas dominating in the center.

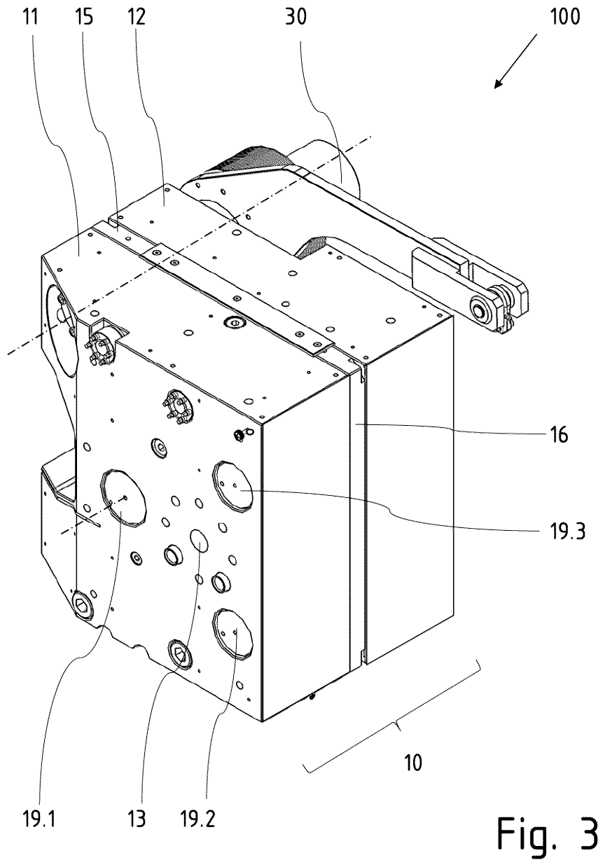

FIG. 3 shows a perspective view of a housing 10 of a screen wheel filter device 100 with a view of an inlet plate 11 including an inlet channel 13. An outlet plate 12 is connected to inlet plate 11 via spacer elements 15, 16, an intermediate space being formed therebetween, in which a screen wheel is mounted. All three adjacent elements of housing 10, i.e., inlet plate 11, spacer elements 15, 16, and outlet plate 12, are screwed to each other via a total of seven housing tensioning bolts 19.1, 19.2, 19.3 and braced against each other with the aid of a pretension configured for the planned operating pressure. The center line of housing tensioning bolt 19.1 in the center of the housing simultaneously forms the rotation axis of the screen wheel. A drive unit 30 for the screen wheel is arranged on the outside of housing 10.

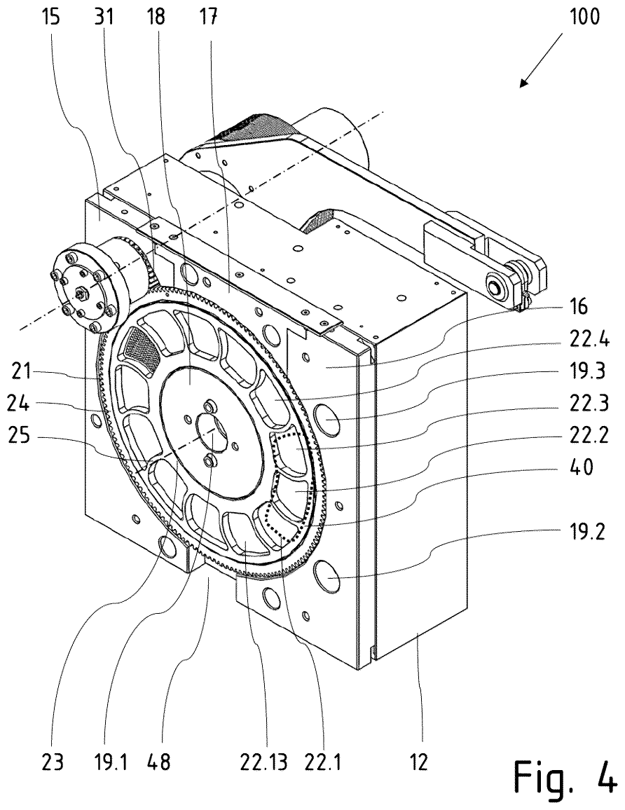

FIG. 4 is a perspective view of screen wheel filter device 100 as in FIG. 1, the inlet plate being removed so that inner screen wheel 20 is visible. A further spacer element 17 is also visible, which connects the two side spacer elements 15, 16 gaplessly to each other on the upper housing edge. Screen wheel 20 is almost completely enclosed thereby on the outer circumference. Openings of housing 10 thus exist only in the lower region in the form of a discharge opening 48, which is used to facilitate the targeted outflow of melt into a collecting container set up below the filter device. In the illustrated example, the filter device includes a drive, which acts upon annular gear 21 via a driving pinion 31. In the case of an alternative drive via a pawl, which engages with a suitable toothing on the outer circumference, the housing has at least one further opening in the upper region at the engagement point of the drive.

Screen wheel 20 is designed with a multiplicity of screen segments 22.1 to 22.13 in a manner which is known per se; in the illustrated example, 13 screen segments are provided. Screen segments 22.1 to 22.13 are each limited by an inner annular sealing strip 23 on the surface of screen wheel 20, an outer annular sealing strip 24, as well as sealing strips 25 extending therebetween, which lead from the inside to the outside. A stationary bearing ring 18 is arranged in the center, on which screen wheel 20 is mounted. A friction bearing is formed between the outside of the bearing ring and the inside of the central bore of screen wheel 20. An annular gear 21 is formed on the outer circumference of screen wheel 20.

Housing tensioning bolts 19.1, 19.2, 19.3 cause a compression of spacer elements 15, 16, 17 clamped between the outer housing plates to occur within a pretensioning area, thereby reducing the distance between inlet and outlet plates 11, 12 and screen wheel 20 enclosed therebetween.

The dot-dash line corresponds to the contours of the funnel-shaped openings of the inlet and outlet channels on screen wheel 20 and represents through-flow region 40, which is usable for the filtration. Screen wheel 20 rotates in the counter-clockwise direction. In the angular position of screen wheel 20 shown in FIG. 2, screen segment 22.1 partially overlaps through-flow region 40. As a result, the operating pressure prevails in entire screen segment 22.1. Screen segment 22.2 is situated entirely within region 40 through which the flow passes. Screen segment 22.3 also partially overlaps through-flow region 40, so that the operating pressure prevails there as well. Screen segment 22.4 is rotated out of region 40 through which the flow passes, the fluid stored therein always being under operating pressure.

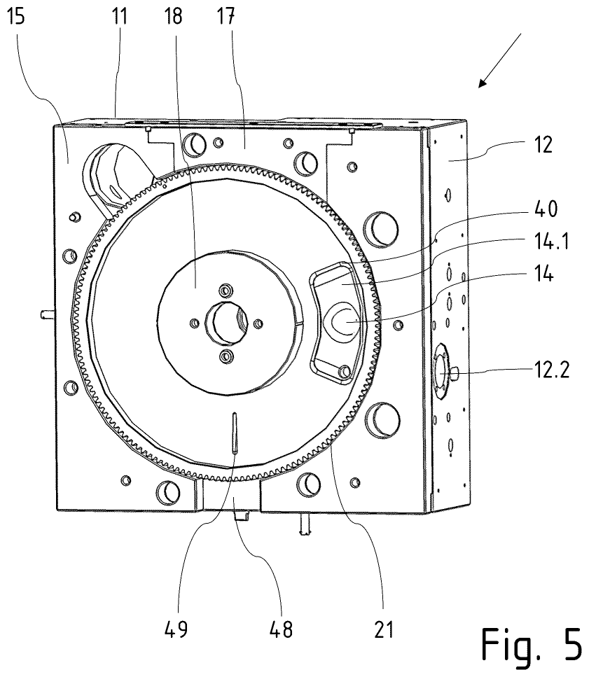

FIG. 5 is a perspective view of screen wheel filter device 100, as in FIGS. 1 and 2, the screen wheel also being removed here; for the purpose of orientation with regard to the position of the screen wheel, only annular gear 21 thereof is indicated. The contour of funnel opening 14.1 of outlet channel 14 corresponds to through-flow region 40. A backflushing channel begins at a side opening 12.2 on outlet plate 12, which opens into an elongated, slit-shaped backflushing nozzle 49 in the lower region of the screen wheel. Fluid emerging during the backflushing flows out at housing opening 48.

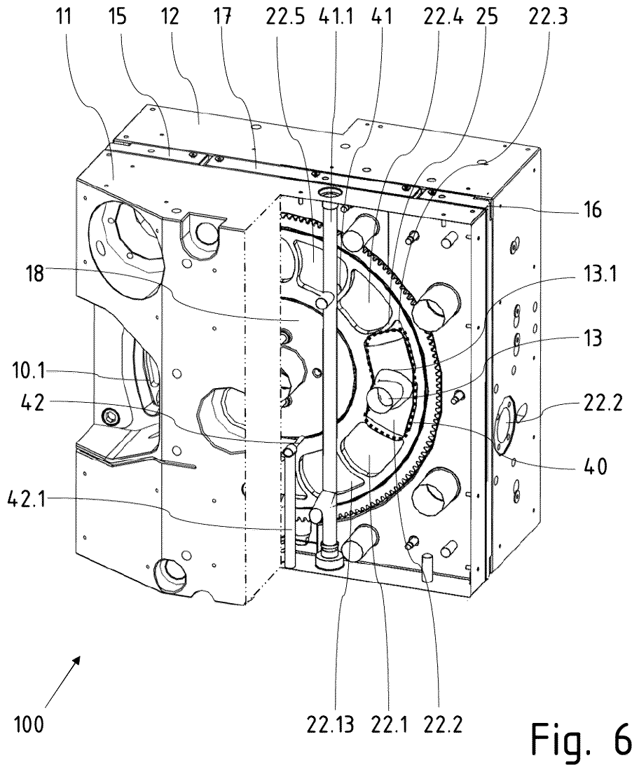

FIG. 6 illustrates filter device 100, including all housing elements 11, 12, 15, 16, 17 and screen wheel 20, the region of housing inlet plate 11 on the right, in which inlet channel 13 is arranged, being partially cut away and illustrated transparently. A screen changing position 10.1 is provided on the left of the housing, at which inlet plate 11 is open so that a changing of the screen elements may take place there. Screen changing position 10.1 may be closed by a door. The widening of inlet channel 13 into a funnel opening 13.1 is clearly apparent. It is equivalent to funnel opening 14.1 (cf. FIG. 3) on outlet plate 12 in terms of position and shape. Through-flow region 40 outlined with a dot-dash line is formed therebetween, in which the plastic melt flows through the screen elements inserted into screen segments 22.1 through 22.13.

At the position of screen wheel 20 in FIG. 6, screen segment 22.5 overlaps with pressure relief bore 41, which is guided laterally to screen wheel 20 and continues downwardly in a pressure relief channel 41.1. The screen cavity at screen segment 22.5 is thus already without pressure. Screen segment 22.4 following counter-clockwise during the rotation is still under high internal pressure. It no longer overlaps through-flow region 40 and is completed cut off from next following screen segment 22.3 by sealing strip 25. Screen segments 22.2, 22.3 are situated entirely within through-flow region 40. Screen segment 22.1 begins to overlap through-flow region 40. If a screen has previously been changed, a preflooding takes place at this point, and the internal pressure decreases.

A further pressure relief bore 42 leads from the side directly into the friction bearing surface area between the inner circumference of the bearing bore of screen wheel 20 and bearing ring 18 fixedly clamped in the housing. It continues downwardly in a further pressure relief channel 42.1.

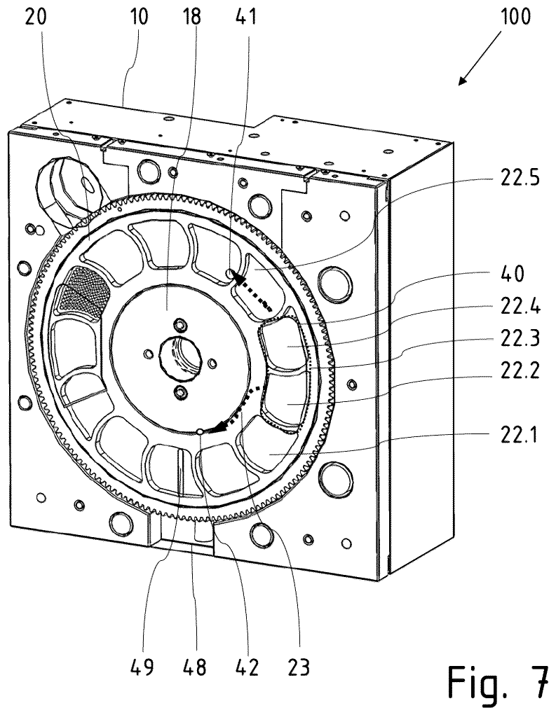

FIG. 7 shows a vertical section of housing 10 with a view of screen wheel 20, the plane of intersection running in an intermediate plane, in which a lubricating gap is formed, and in parallel to the plane of screen wheel 20. The dotted arrows indicate the approximate flow directions of the plastic melt from screen segments 22.2, 22.3 in through-flow region 40 or in the vicinity thereof in the direction of pressure relief bores 41, 42. They differ from each other in that the flow to first pressure relief bore 41 in the upper area takes place in the path of screen segments 22.1 to 22.13 of the screen wheel, and is thus “tangential,” while the flow to second pressure relief bores 42 in the lower area overcomes inner annular sealing strip 23 on screen wheel 20 and is therefore referred to as “radial.”

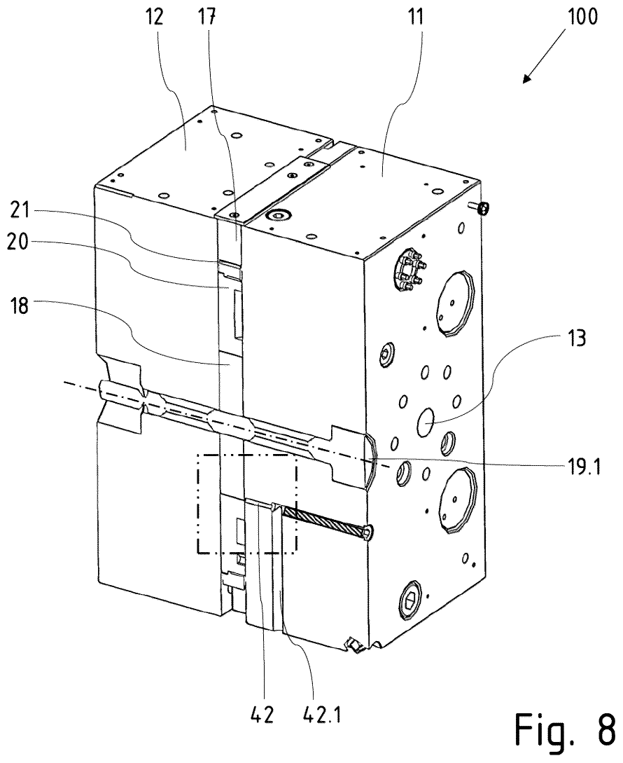

FIG. 8 shows a perspective sectional view of the rotation axis of screen wheel 20, which is simultaneously the center line of housing tensioning bolt 19.1 and bearing ring 18. Lower pressure relief bore 42, which continued downwardly in pressure relief channel 42.1, is arranged in the plane of intersection.

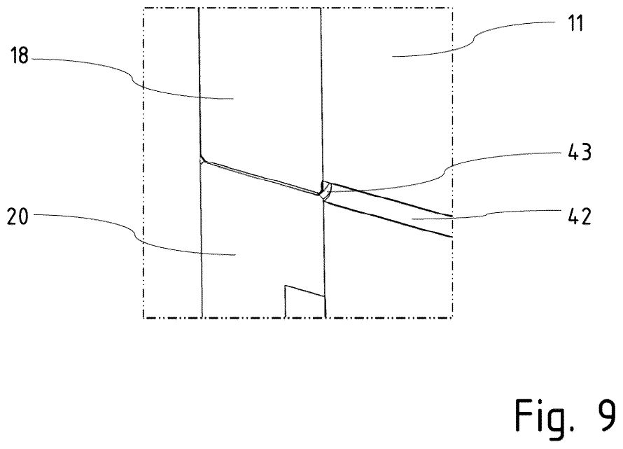

One important detail with regard to the pressure relief effectuated with the aid of second pressure relief bore 42, the so-called “radial” pressure relief, becomes clear in FIG. 9 only by enlarging a section from FIG. 8. In the location where bearing ring 18 and the bore of screen wheel 20 abut each other and form a friction bearing, bearing ring 20 and screen wheel 20 are each provided with a chamfer, so that, due to the two neighboring chamfers, a ring channel 43 having a triangular cross-section is formed, which is significantly larger in volume compared to the annular gap of friction bearing 26, and which facilitates the removal of plastic melt for the purpose of pressure relief without otherwise having to change housing parts or the pairing of screen wheel 20 and bearing ring 18.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A screen wheel filter device for a high-pressure filtration of a plastic melt, the screen wheel filter device comprising:
a housing that has an inlet plate having at least one inlet channel and an outlet plate having at least one outlet channel;
at least one spacer element arranged between the inlet plate and the outlet plate;
a bearing ring on which a screen wheel is arranged between the inlet plate and the outlet plate, the screen wheel being rotatably mounted;
a central tensioning bolt, which is guided through the bearing ring, via which the inlet plate together with the outlet plate and the bearing ring inserted therebetween, is braced;
at least two screen segments arranged on the screen wheel, each of the at least two screen segments being positionable between the inlet and outlet channels and through which a flow passes;
a through-flow region formed between openings of the inlet channel and the outlet channel facing toward the screen wheel, surfaces projected onto the inlet and outlet plates of all screen segments at least partially overlapping the through-flow region and together form an active pressure surface region; and
a lubricating gap formed between a sealing strip sealing surface of the screen wheel and an inner surface of the inlet plate as well as an inner surface of the outlet plate,
wherein a cross-sectional area of the bearing ring is at least 9 times a cross-sectional area of the central tensioning bolt, and
wherein the cross-sectional area the central tensioning bolt being is 0.1 times to 0.4 times an area of the active pressure surface region.

2. The screen wheel filter device according to claim 1, wherein a middle length of an arc-shaped active pressure surface region is 1.9 times to 2.5 times the width.

3. The screen wheel filter device according to claim 1, wherein a thickness of the inlet block and the outlet block is in each case at least 2.5 times to 3.5 times a diameter of the tensioning bolt.

4. The screen wheel filter device according to claim 1, wherein at least one pressure relief bore is provided in the inlet plate and/or in the outlet plate, which opens into the path over which the screen segments pass during the rotation of the screen wheel, and which is fluid-conductively connected to an outside of the housing via a pressure relief channel; and wherein, if one screen segment overlaps at least one pressure relief bore, the screen segment does not overlap the through-flow region.

5. The screen wheel filter device according to claim 4, wherein at least one tangential pressure relief flow path is formed within at least one lubricating gap, which extends between one of the openings of the inlet channel or the outlet channel and at least one pressure relief bore which opens upstream from the through-flow region in the rotation direction.

6. The screen wheel filter device according to claim 5, wherein a distance between the opening of the pressure relief bore and a front edge of the through-flow region in a rotation direction is greater than a maximum extension of the screen segments in the rotation direction.

7. The screen wheel filter device according to claim 1, wherein at least one radial pressure relief flow path is formed within at least one lubricating gap, which extends between the through-flow region and at least one pressure relief bore, which is provided in the inlet plate and/or in the outlet plate, the pressure relief bore opening on the bearing ring and being fluid-conductively connected to an outside of the housing via a pressure relief channel formed in the housing.

8. The screen wheel filter device according to claim 7, wherein a ring channel is formed in the screen wheel and/or in the housing, which is in flow connection with an annular friction bearing formed between the bearing ring and the screen wheel.

9. The screen wheel filter device according to claim 8, wherein the ring channel is formed by a chamfer on the outer circumference of the bearing ring and a chamfer on the inner circumference of the bore in the screen wheel receiving the bearing ring.

10. The screen wheel filter device according to claim 1, wherein a cross-sectional area of the bearing ring is no more than 13 times a cross-sectional area of the tensioning bolt.
